(19) United States
(12) Patent Application Publication
(10) Pub. No.: US 2016/0246391 A1
(43) Pub. Date: Aug. 25, 2016

(54) PEN NIB

(71) Applicants: TEIBOW CO., LTD, Hamamatsu-shi, Shizuoka (JP); NISHIURA CHEMISTRY CO., LTD., Gamagori-shi, Aichi (JP); NISSEN CO., LTD., Habikino-shi, Osaka (JP)

(72) Inventors: Michihiro Yamada, Hamamatsu-shi, Shizuoka (JP); Hiroshi Nishikawa, Habikino-shi, Osaka (JP); Masami Hashimoto, Gamagori-shi, Aichi (JP)

(21) Appl. No.: 15/029,921

(22) PCT Filed: Oct. 16, 2014
(86) PCT No.: PCT/JP2014/077595

§ 371 Date: Apr. 15, 2016

(30) Foreign Application Priority Data
Oct. 16, 2013 (JP) 2013-215886

(51) Int. Cl. G06F 3/0354; G06F 3/039

(52) U.S. Cl. CPC G06F 3/03545; G06F 3/039; G06F 3/044

(57) ABSTRACT

An object is to provide a pen nib that can be used, for example, for a touch panel with writing feeling comparable to a conventional pen.

The pen nib has a pen nib body that is formed of a bundle of fibers and is coated with a conductive material and made conductive.

### TECHNICAL FIELD

The present invention relates to a pen nib of a touch pen for a capacitive touch panel or the like.

### BACKGROUND ART

In recent years, capacitive touch panels have become available, which are configured to operate, for example, in response to a detection of a position of a finger on the touch panel based on capacitance change obtained between the finger and a conductive film of the touch panel. Under the circumstances, there has been a demand from touch panel users for a touch pen that can be handled well on a touch panel, and a known example of such a touch pen is a stylus pen for a touch panel that has a tip end made of a hard material that slides well.

### CITATION LIST

### Patent Literature

[Patent Literature 1] Japanese Patent Application Laid-open No. 2012-53681

### SUMMARY OF INVENTION

### Technical Problem

However, the stylus pen for a touch panel as described above having a hard tip end may be slippery on a touch panel and requires delicate handling, and therefore a user cannot input with usual writing feeling.

The present invention has been made in view of the above-described problem and an object of the present invention is to provide a pen nib that can be used, for example, on a touch panel and that provides writing feeling comparable to a usual pen by using a conventional pen nib body formed of a bundle of fibers and by making the pen nib body conductive.

### Solution to Problem

In order to solve the above-described problem,

according to a first aspect of the invention, a pen nib body formed of a bundle of fibers is coated with a conductive material and made conductive.

According to a second aspect of the invention, pyrrole is used as the conductive material.

According to a third aspect of the invention, the pen nib body is formed of a bundle of fibers produced by binding synthetic fibers with a binder, the bundle of fibers has a porosity from 20% to 80%, and the ratio of the binder relative to the total weight is from 1% to 40%.

### Advantageous Effects of Invention

According to the first aspect of the invention, a pen nib that can be used, for example, on a touch panel that provides writing feeling comparable to a conventional pen nib formed of a bundle of fibers can be provided.

According to the second aspect of the invention, a film thickness of the conductive material for coating the bundle of fibers can be reduced, therefore a pen nib can be provided, which can be used, for example, on a touch panel without changing writing feeling of the pen nib formed of the bundle of fibers.

According to the third aspect of the invention, sufficient conductivity is ensured for a pen nib of a touch pen can be provided.

### BRIEF DESCRIPTION OF DRAWINGS

FIG. 1 is a view of an example of a pen nib according to the present invention showing a rod-shaped pen nib 1.

FIG. 2 is a view of an example of a pen nib according to the present invention showing a brush-shaped pen nib 1.

FIG. 3 is a sectional view of a pen nib 1 according to the present invention mounted to a holder tube 2.

FIG. 4 is a view of a pen nib 1 according to the present invention wrapped, for example, with a conductive fabric 3 having conductivity.

### DESCRIPTION OF EMBODIMENTS

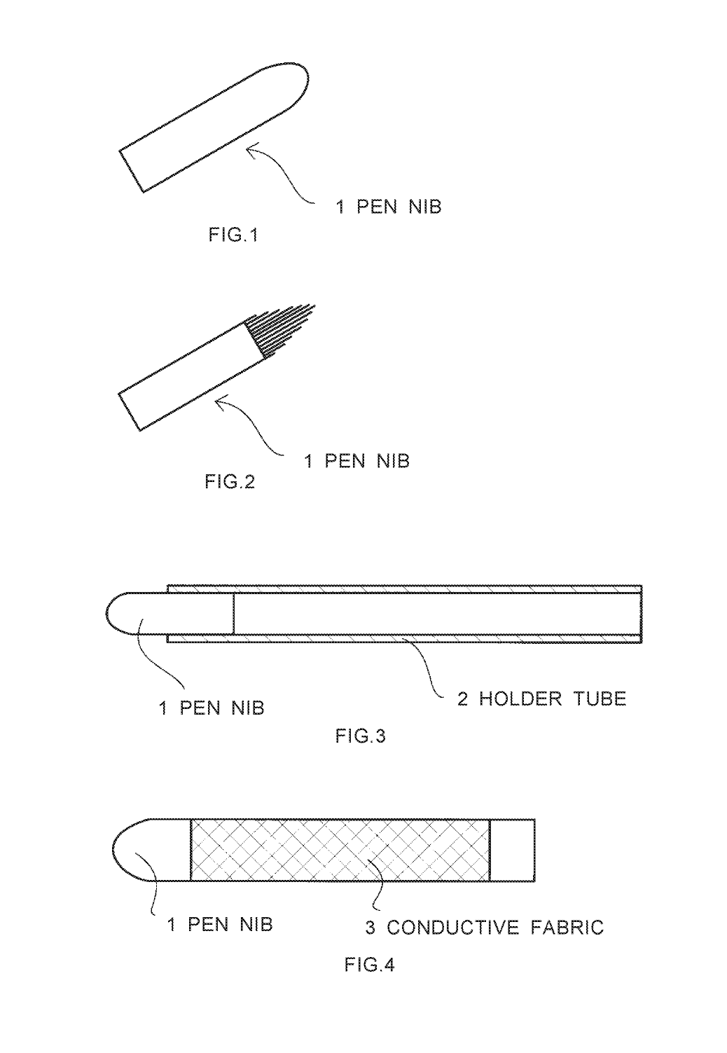

A pen nib according to the present invention is described by referring to a rod-shaped pen nib 1 as shown in FIG. 1 as an example.

The pen nib 1 according to the present invention is formed by carrying out conductive processing on a pen nib body formed of a bundle of fibers obtained by binding synthetic fibers with a binder.

(Structure of Pen Nib Body)

The pen nib body is formed using a bundle of fibers obtained by binding synthetic fibers such as polyester fiber, nylon fiber, and acrylic fiber with a binder such as polyurethane resin, phenoxy resin, epoxy resin, and melamine resin. The synthetic fibers for use may include staple or filament.

In a manufacture of the pen nib body described above, depending on, for example, desired writing feeling/smoothness for the pen nib, a necessary ground area, and an electric leakage-resistant value for the pen nib, a fiber diameter of the synthetic fiber for use, the ratio of the binder to the total weight, and the fiber density of the bundle of fibers are set as desired and the porosity and cross-sectional hardness of the transverse section center part (durometer hardness: type JISK6301 A) of the bundle of fibers are adjusted.

As for the fiber diameter of the synthetic fiber, the fiber diameter exceeding 20 denier leads to roughness in term of writing feeling and results in reduced slidability. The fiber diameter less than 0.2 denier leads to difficulty in manufacturing and handling even though there is no problem about writing feeling/smoothness, which would not be economically advantageous. Therefore, an appropriate fiber diameter for the synthetic fiber is about in a range approximately from 0.2 denier to 20 denier.

When the ratio of the binder to the total weight is 50% or more, a resulting pen nib is too hard to yield and it is difficult to have a necessary ground area, and the synthetic fiber is coated with the binder, which weakens the conductive processing, and as a result the pen nib cannot be provided with sufficient conductivity. On the other hand, when the ratio is less than 1%, the fibers cannot be bound sufficiently, and the bundle of fibers becomes too soft and tends to come apart. An appropriate ratio of the binder to the total weight is therefore about in the range from 1% to 40%.

When the fiber density of the bundle of fibers is 7500 denier/mm² or more, a resulting pen nib is hard, a necessary ground area cannot be obtained, gaps between the fibers are so small that a conductive process liquid cannot pass between the fibers during conductive processing, and the bundle of fibers cannot be made conductive thoroughly in the inside thereof. When the fiber density is less than 1500 denier/mm², a resulting bundle of fibers is soft and tends to come apart. The appropriate fiber density of the bundle of fibers is therefore about in the range from 1500 denier/mm² to 7500 denier/mm².

The porosity of the bundle of fibers can be adjusted depending on the amount of the binder and the fiber density of the bundle of fibers, and the porosity increases as the amount of the binder is reduced or the fiber density of the bundle of fibers is reduced, as a result the conductive process liquid can sufficiently pass between the fibers during conductive processing, which facilitates the conductive processing, and a pen nib with soft writing feeling can be obtained. However, when the porosity is 80% or more, the bundle of fibers becomes too soft and tends to come apart.

Conversely, as the amount of the binder increases or the fiber density of the bundle of fibers increases, the porosity is reduced, and a less yielding highly durable pen nib with hard writing feeling can be obtained. When however the porosity is 20% or less, the conductive process liquid cannot pass sufficiently between the fibers during conductive processing, and as a result the bundle of fibers cannot be made conductive thoroughly in the inside thereof.

The cross-sectional hardness of the transverse section center part of the bundle of fibers (durometer hardness: type: JISK6301A) can be adjusted by changing the fiber diameter, the ratio of the binder, and the fiber density, and as the fiber diameter, the amount of the binder, and the fiber density of the bundle of fibers are increased, the cross-sectional hardness of the transverse section center part is increased, and as a result a less yielding and highly durable pen nib can be obtained, although the pen nib exhibits an increase in resistance in terms of writing feeling/smoothness. However, when the cross-sectional hardness of the transverse section center part is 100 or more, a resulting pen nib is too hard to yield, and a necessary ground area cannot be obtained.

Conversely, as the fiber diameter, the amount of the binder, and the fiber density of the bundle of fibers are reduced, the cross-sectional hardness of the transverse section center part is reduced, and as a result a more yielding pen nib with good writing feeling/smoothness can be obtained. However, when the cross-sectional hardness of the transverse section center part is 4 or less, a resulting bundle of fibers is too soft and tends to come apart.

It should be noted that the cross-sectional hardness of the transverse section center part can also be adjusted by changing the hardness of the binder or the fiber or the distribution of the binder, and the cross-sectional hardness of the transverse section center part can be increased by increasing the hardness of the binder or the fiber or increasing the center part of the distribution of the binder, while conversely the cross-sectional hardness of the transverse section center part can be reduced by reducing the hardness of the binder or the fiber or reducing the center part of the distribution of the binder.

The pen nib body illustrated in FIG. 2 is formed by producing the pen nib body that can easily come apart by adjusting the fiber density etc., and cutting a tip end surface of the produced pen nib body when, for example, a rod-shaped pen nib body shown in FIG. 1 is produced. Then the fiber comes apart and can provide brush-shaped writing feeling. It should be noted that the shape of the pen nib body is not limited to those shown in FIGS. 1 and 2, and may be any of various shapes having its tip end formed, for example, in a rectangular or spherical shape.

(Conductive Processing)

The pen nib body formed as described above can be subjected to conductive processing by coating the synthetic fiber that forms the pen nib body with a conductive material. A method of coating the synthetic fiber that forms the pen nib body with a conductive material can be carried out by integrating the synthetic fiber of the pen nib body with a conductive polymer—polypyrrole—obtained by polymerization according to a known method disclosed by Japanese Patent No. 3855208.

For example, a pen nib body formed of a bundle of fibers as shown in FIG. 1 or 2 is placed in an open furnace, ion exchanged water is added into the oven furnace thus having the pen nib body inside so that the bath ratio is 1:10 to 15, and the temperature is raised to 80 deg C. with stirring using a stirrer. After the temperature is reached, a polyamide-based FIX agent (such as a product of sulfonation of a 4,4′-dihydroxyphenyl sulfone-formalin condensate) in an amount equivalent to about 4% of the total amount is added and the mixture is allowed to stand for 30 minutes. After the 30 minutes, the pen nib is taken out and subjected to a rinse/dehydration process.

After the pen nib is again placed in the open furnace, ion exchanged water is added in the bath ratio of 1:10 to 15, followed by stirring using a stirrer, and a pyrrole-containing solution is added, and the pyrrole monomer was subjected to a polymerization reaction with stirring for two hours. After the two hours, the pen nib is taken out, subjected to a rinse/dehydration process, and dried. In this way, the conductive processing on the pen nib body can be carried out.

Since polypyrrole is sufficiently conductive if formed as a thin film (even as thin as about 0.1 μm), the polypyrrole film for coating the synthetic fiber of the pen nib body may be thin, which hardly have effect on writing feeling of the pen nib before the conductive processing, as compared to effect by other conductive processing. Moreover, since the film thickness necessary for the conductive processing is small, the synthetic fiber inside the pen nib can readily be provided with required conductivity if the porosity is relatively small.

Here, in order to simply provide the pen nib body with conductivity, the synthetic fibers forming a surface of the pen nib only need to be coated with a conductive material, so that the surface of the pen nib is made conductive and available as a pen nib for a capacitive touch panel. However, when only the surface of the pen nib body is coated with the conductive material, the conductive material may be worn away or the synthetic fiber itself may be worn and cannot keep good conductivity after a long period of use.

It is therefore advantageous to adjust the porosity or the like of the bundle of fibers forming the pen nib body, so that the synthetic fibers forming the inside of the pen nib body is also coated with the conductive material, and the pen nib can be kept stably conductive over a long period of time.

Since the resistance value of a human fingertip is about 100 kΩ, a resistance value for the pen nib after receiving the conductive processing may be set to at most 100 kΩ, so that the pen nib would have operability substantially equal to operability by a fingertip, but the value is preferably 80 kΩ or less if resistance, for example, by holding is taken into account. It should be noted that a resistance value of 100 kΩ or more does not prevent operation, and the resistance value can be set as required in a range that allows the pen nib to be operated as a pen nib for a touch pen in consideration of durability, costs, and other factors.

(Forming of Pen)

As shown in FIG. 3, the pen nib provided with conductivity is configured such that the pen nib 1 is mounted to a holder tube 2 made of a metal such as aluminum or resin having conductivity (such as nylon resin containing carbon fiber) whereby the pen can be used like a usual pen. Alternatively, as shown in FIG. 4, the pen nib 1 may be directly wrapped, for example, with conductive resin or the pen nib 1 may be held directly for use on a touch panel just like a piece of chalk used on a blackboard.

### EXAMPLES

Examples of the present invention is described in the following.

It should be noted that an evaluation method as follows was employed.

Resistance value: A resistance value from end to end in a length-wise direction was measured using an insulation resistance tester (KF-20 manufactured by KAISE CORPORATION).

Inside state: A pen nib was severed using a cutter, the inside of the pen nib was visually checked, and the result was denoted by “O” when the pen nib was coated with polypyrrole through the fiber inside the pen nib and by “X” when the fiber inside the pen nib was not coated with polypyrrole.

Durability: Assuming normal use states, the pen nib was slid on a touch panel surface with a load of 50 gf, at a speed of 70 mm/s, and at a pen nib angle of 65 deg. The pen nib was moved back and forth 250 times for a distance of 20 cm and then visually checked, and the result was denoted by “O” when any damage that would impair the function of the pen nib was not found and by “X” when a damage that would impair the function of the pen nib was found.

Secured ground area: With a load of 50 gf, the result was denoted by “O” when a ground area of at least 5 mm² was secured and by “X” when an obtained ground area was less than 5 mm².

Dynamic friction coefficient: Assuming normal use states, the pen nib was slid on a touch panel surface with a load of 50 gf, at a speed of 70 mm/s, and at a pen nib angle of 65 deg, and the dynamic friction coefficient was measured using a static/dynamic friction measurement device (TL20Ts manufactured by Trinity-Lab Inc.). Writing feeling/smoothness: The result was denoted by “O” when a measured dynamic friction coefficient was in the range from 0.15 to 0.4, therefore the writing feeling/smoothness was good and by “X” when the coefficient was outside the range because the resultant pen nib was slippery for a coefficient less than 0.15 and did not slide well for a coefficient of 0.4 or more.

### First Example

Using 3 denier nylon fiber and urethane resin as a binder, a rod-shaped pen nib body formed of a bundle of fibers and having a diameter of about 5 mm and a length of about 18 mm was produced. When the amount of the binder was adjusted to be 4%, and the fiber density was adjusted to be 2675 denier/mm², the porosity of the produced pen nib body was 67%, and the cross sectional hardness of the transverse section center part (hereinafter referred to as “cross-sectional hardness”) was 37. The produced pen nib body was placed in an open furnace, ion exchanged water was added into the oven furnace having the pen nib body inside so that the bath ratio would be 1:10 to 15, and the temperature was raised to 80 deg C with stirring by a stirrer. After the temperature was reached, a polyamide-based FIX agent (such as a product of sulfonation of a 4,4′-dihydroxyphenyl sulfone-formalin condensate) in an amount equivalent to about 4% of the total amount was added, the mixture was then allowed to stand for 30 minutes, and the pen nib body was taken out after the 30 minutes and subjected to a rinse/dehydration process.

After the pen nib body was again placed in the open furnace, ion exchanged water was added in a bath ratio of 1:10 to 15, a pyrrole containing solution was added with stirring using a stirrer so that the amount of pyrrole would be equivalent to about 3% of the total amount, and the pyrrole monomer was subjected to a polymerization reaction with stirring for two hours. After the two hours, the pen nib was taken out, subjected to a rinse/dehydration process, and dried.

The thus obtained pen nib integrated with polypyrrole had an electric leakage-resistant value of 70×10³ Ω/cm. The pen nib was severed using a cutter, and it was observed that the fiber inside the pen nib was coated with polypyrrole.

Moreover, there was no problem about the durability, and a ground area set based on pressure equivalent to pressure in use was secured. A measured dynamic friction coefficient was 0.30, and there was no problem about the writing feeling/smoothness.

### Second Example

A rod-shaped pen nib body was produced according to the same method as that in First Example. The produced pen nib body was placed in an open furnace, ion exchanged water was added into the oven furnace including the pen nib body inside so that the bath ratio would be 1:10 to 15, and the temperature was raised to 80 deg C. with stirring using a stirrer. After the temperature was reached, a polyamide-based FIX agent (such as a product of sulfonation of a 4,4′-dihydroxyphenyl sulfone-formalin condensate) in an amount equivalent to about 4% of the total amount was added, the mixture was then allowed to stand for 30 minutes, and the pen nib body was taken out after the 30 minutes and subjected to an rinse/dehydration process.

After the pen nib body was again placed in the open furnace, ion exchanged water was added in a bath ratio of 1:10 to 15, a pyrrole containing solution was added with stirring using a stirrer so that the amount of pyrrole would be equivalent to about 4% of the total amount, and then the pyrrole monomer was subjected to a polymerization reaction with stirring for two hours. After the two hours, the pen nib was taken out, subjected to a rinse/dehydration process, and dried.

The thus obtained pen nib integrated with polypyrrole had an electric leakage-resistant value of 1×10³ Ω/cm. The pen nib was severed by a cutter, and it was observed that the fiber inside the pen nib was coated with polypyrrole.

There was no problem about the durability, and a ground area set based on pressure equivalent to pressure in use was secured. A measured dynamic friction coefficient was 0.30, and there was no problem about the writing feeling/smoothness.

### Third Example

Using 3 denier nylon fiber and urethane resin as a binder, a rod-shaped pen nib body formed of a bundle of fibers and having a diameter of about 5 mm and a length of about 18 mm was produced. When the amount of the binder was adjusted to be 1%, and the fiber density was adjusted to be 2675 denier/mm², the porosity of the produced pen nib body was 70%, and the cross sectional hardness was 25. The produced pen nib body was pretreated according to the same method as that in Second Example, and then the pyrrole monomer was subjected to a polymerization reaction according to the same method as that in Second Example. (In other words, the produced pen nib body was placed in an open furnace, ion exchanged water was added into the oven furnace including the pen nib body inside so that the bath ratio would be 1:10 to 15, and the temperature was raised to 80 deg C. with stirring using a stirrer. After the temperature was reached, a polyamide-based FIX agent (such as a product of sulfonation of a 4,4′-dihydroxyphenyl sulfone-formalin condensate) in an amount equivalent to about 4% of the total amount was added, the mixture was allowed to stand for 30 minutes, the pen nib body was then taken out after the 30 minutes, subjected to a rinse/dehydration process, and then again placed in the open furnace, after which ion exchange water was added in a bath ratio of 1:10 to 15, a pyrrole containing solution was added with stirring using a stirrer so that the amount of pyrrole would be equivalent to about 4% of the total amount, and the pyrrole monomer was subjected to a polymerization reaction with stirring for two hours. After the two hours, the pen nib was taken out, subjected to a rinse/dehydration process, and dried).

The thus obtained pen nib integrated with polypyrrole had an electric leakage-resistant value of 1×10³ Ω/cm. The pen nib was severed by a cutter, and it was observed that the fiber inside the pen nib was coated with pyrrole.

There was no problem about the durability, and a ground area set based on pressure equivalent to pressure in use was secured. A measured dynamic friction coefficient was 0.28, and there was no problem about the writing feeling/smoothness.

### Fourth Example

Using 3 denier nylon fiber and urethane resin as a binder, a rod-shaped pen nib body formed of a bundle of fibers and having a diameter of about 5 mm and a length of about 18 mm was produced. When the amount of the binder was adjusted to be 10%, and the fiber density was adjusted to be 2675 denier/mm², the porosity of the produced pen nib body was 62%, and the cross sectional hardness was 43.

The produced pen nib body was pretreated according to the same method as that in Second Example, and then the pyrrole monomer was subjected to a polymerization reaction according to the same method as that in Second Example.

The thus obtained pen nib integrated with polypyrrole had an electric leakage-resistant value of 1×10³ Ω/cm. The pen nib was severed by a cutter, and it was observed that the fiber inside the pen nib was coated with polypyrrole.

There was no problem about the durability, and a ground area set based on pressure equivalent to pressure in use was secured. A measured dynamic friction coefficient was 0.33, and there was no problem about the writing feeling/smoothness.

### Fifth Example

Using 3 denier nylon fiber and urethane resin as a binder, a rod-shaped pen nib body formed of a bundle of fibers and having a diameter of about 5 mm and a length of about 18 mm was produced. When the amount of the binder was adjusted to be 40%, and the fiber density was adjusted to be 2675 denier/mm², the porosity of the produced pen nib body was 50%, and the cross sectional hardness was 50.

The produced pen nib body was pretreated according to the same method as that in Second Example, and then the pyrrole monomer was subjected to a polymerization reaction according to the same method as that in Second Example.

The thus obtained pen nib integrated with polypyrrole had an electric leakage-resistant value of 50×10³ Ω/cm. The pen nib was severed by a cutter, and it was observed that the fiber inside the pen nib was coated with polypyrrole.

There was no problem about the durability, and a ground area set based on pressure equivalent to pressure in use was secured. A measured dynamic friction coefficient was 0.35, and there was no problem about the writing feeling/smoothness.

### Sixth Example

Using 3 denier nylon fiber and urethane resin as a binder, a rod-shaped pen nib body formed of a bundle of fibers and having a diameter of about 5 mm and a length of about 18 mm was produced. When the amount of the binder was adjusted to be 50%, and the fiber density was adjusted to be 2675 denier/mm², the porosity of the produced pen nib body was 43%, and the cross sectional hardness was 70.

The produced pen nib body was pretreated according to the same method as that in Second Example, and then the pyrrole monomer was subjected to a polymerization reaction according to the same method as that in Second Example.

The thus obtained pen nib integrated with polypyrrole had an electric leakage-resistant value of 90×10³ Ω/cm. The pen nib was severed by a cutter, and it was observed that the fiber inside the pen nib was not coated with polypyrrole.

There was no problem about the durability, and a ground area set based on pressure equivalent to pressure in use was secured. A measured dynamic friction coefficient was 0.38, and there was no problem about the writing feeling/smoothness.

### Seventh Example

Using 3 denier nylon fiber and urethane resin as a binder, a rod-shaped pen nib body formed of a bundle of fibers and having a diameter of about 5 mm and a length of about 18 mm was produced. When the amount of the binder was adjusted to be 55%, and the fiber density was adjusted to be 2675 denier/mm², the porosity of the produced pen nib body was 40%, and the cross sectional hardness was 80.

The produced pen nib body was pretreated according to the same method as that in Second Example, and then the pyrrole monomer was subjected to a polymerization reaction according to the same method as that in Second Example.

The thus obtained pen nib integrated with polypyrrole had an electric leakage-resistant value of 150×10³ Ω/cm. The pen nib was severed by a cutter, and it was observed that the fiber inside the pen nib was not coated with polypyrrole.

There was no problem about the durability, but a ground area set based on pressure equivalent to pressure in use was not secured. A measured dynamic friction coefficient was 0.34, and there was no problem about the writing feeling/smoothness.

### Eighth Example

Using 3 denier nylon fiber and urethane resin as a binder, a rod-shaped pen nib body formed of a bundle of fibers and having a diameter of about 5 mm and a length of about 18 mm was produced. When the amount of the binder was adjusted to be 4%, and the fiber density was adjusted to be 1300 denier/mm², the porosity of the produced pen nib body was 85%, and the cross sectional hardness was 3.

The produced pen nib body was pretreated according to the same method as that in Second Example, and then the pyrrole monomer was subjected to a polymerization reaction according to the same method as that in Second Example.

The thus obtained pen nib integrated with polypyrrole had an electric leakage-resistant value of 1×10³ Ω/cm. The pen nib was severed by a cutter, and it was observed that the fiber inside the pen nib was coated with pyrrole.

As for the durability, some damage was observed, but a ground area set based on pressure equivalent to pressure in use was secured. A measured dynamic friction coefficient was 0.14, and as for the writing feeling/smoothness, it was slippery.

### Ninth Example

Using 3 denier nylon fiber and urethane resin as a binder, a rod-shaped pen nib body formed of a bundle of fibers and having a diameter of about 5 mm and a length of about 18 mm was produced. When the amount of the binder was adjusted to be 4%, and the fiber density was adjusted to be 2000 denier/mm², the porosity of the produced pen nib body was 76%, and the cross sectional hardness was 25.

The produced pen nib body was pretreated according to the same method as that in Second Example, and then the pyrrole monomer was subjected to a polymerization reaction according to the same method as that in Second Example.

The thus obtained pen nib integrated with polypyrrole had an electric leakage-resistant value of 1×10³ Ω/cm. The pen nib was severed by a cutter, and it was observed that the fiber inside the pen nib was coated with polypyrrole.

As for the durability, some damage was observed, but a ground area set based on pressure equivalent to pressure in use was secured. A measured dynamic friction coefficient was 0.31, and there was no problem about the writing feeling/smoothness.

### Tenth Example

Using 3 denier nylon fiber and urethane resin as a binder, a rod-shaped pen nib body formed of a bundle of fibers and having a diameter of about 5 mm and a length of about 18 mm was produced. When the amount of the binder was adjusted to be 4%, and the fiber density was adjusted to be 4000 denier/mm², the porosity of the produced pen nib body was 55%, and the cross sectional hardness was 48.

The produced pen nib body was pretreated according to the same method as that in Second Example, and then the pyrrole monomer was subjected to a polymerization reaction according to the same method as that in Second Example.

The thus obtained pen nib integrated with polypyrrole had an electric leakage-resistant value of 70×10³ Ω/cm. The pen nib was severed by a cutter, and it was observed that the fiber inside the pen nib was coated with polypyrrole.

There was no problem about the durability, and a ground area set based on pressure equivalent to pressure in use was secured. A measured dynamic friction coefficient was 0.31, and there was no problem about the writing feeling/smoothness.

### Eleventh Example

Using 3 denier nylon fiber and urethane resin as a binder, a rod-shaped pen nib body formed of a bundle of fibers and having a diameter of about 5 mm and a length of about 18 mm was produced. When the amount of the binder was adjusted to be 4%, and the fiber density was adjusted to be 5000 denier/mm², the porosity of the produced pen nib body was 35%, and the cross sectional hardness was 60.

The produced pen nib body was pretreated according to the same method as that in Second Example, and then the pyrrole monomer was subjected to a polymerization reaction according to the same method as that in Second Example.

The thus obtained pen nib integrated with polypyrrole had an electric leakage-resistant value of 80×10³ Ω/cm. The pen nib was severed by a cutter, and it was observed that the fiber inside the pen nib was coated with polypyrrole.

There was no problem about the durability, and a ground area set based on pressure equivalent to pressure in use was secured. A measured dynamic friction coefficient was 0.32, and there was no problem about the writing feeling/smoothness.

### Twelfth Example

Using 3 denier nylon fiber and urethane resin as a binder, a rod-shaped pen nib body formed of a bundle of fibers and having a diameter of about 5 mm and a length of about 18 mm was produced. When the amount of the binder was adjusted to be 4%, and the fiber density was adjusted to be 6000 denier/mm², the porosity of the produced pen nib body was 22%, and the cross sectional hardness was 73.

The produced pen nib body was pretreated according to the same method as that in Second Example, and then the pyrrole monomer was subjected to a polymerization reaction according to the same method as that in Second Example.

The thus obtained pen nib integrated with polypyrrole had an electric leakage-resistant value of 80×10³ Ω/cm. The pen nib was severed by a cutter, and it was observed that the fiber inside the pen nib was coated with polypyrrole.

There was no problem about the durability, and a ground area set based on pressure equivalent to pressure in use was not secured. A measured dynamic friction coefficient was 0.31, and there was no problem about the writing feeling/smoothness.

### Thirteenth Example

Using 3 denier nylon fiber and urethane resin as a binder, a rod-shaped pen nib body formed of a bundle of fibers and having a diameter of about 5 mm and a length of about 18 mm was produced. When the amount of the binder was adjusted to be 4%, and the fiber density was adjusted to be 7600 denier/mm², the porosity of the produced pen nib body was 18%, and the cross sectional hardness was 80.

The produced pen nib body was pretreated according to the same method as that in Second Example, and then the pyrrole monomer was subjected to a polymerization reaction according to the same method as that in Second Example.

The thus obtained pen nib integrated with polypyrrole had an electric leakage-resistant value of 100×10³ Ω/cm. The pen nib was severed by a cutter, and it was observed that the fiber inside the pen nib was not coated with polypyrrole.

There was no problem about the durability, and a ground area set based on pressure equivalent to pressure in use was not secured. A measured dynamic friction coefficient was 0.30, and there was no problem about the writing feeling/smoothness.

### Fourteenth Example

Using 0.7 denier nylon fiber and urethane resin as a binder, a rod-shaped pen nib body formed of a bundle of fibers and having a diameter of about 5 mm and a length of about 18 mm was produced. When the amount of the binder was adjusted to be 4%, and the fiber density was adjusted to be 2675 denier/mm², the porosity of the produced pen nib body was 67%, and the cross sectional hardness was 18.

The produced pen nib body was pretreated according to the same method as that in Second Example, and then the pyrrole monomer was subjected to a polymerization reaction according to the same method as that in Second Example.

The thus obtained pen nib integrated with polypyrrole had an electric leakage-resistant value of 1×10³ Ω/cm. The pen nib was severed by a cutter, and it was observed that the fiber inside the pen nib was coated with polypyrrole.

There was no problem about the durability, and a ground area set based on pressure equivalent to pressure in use was secured. A measured dynamic friction coefficient was 0.20, and there was no problem about the writing feeling/smoothness.

### Fifteenth Example

Using 1 denier nylon fiber and urethane resin as a binder, a rod-shaped pen nib body formed of a bundle of fibers and having a diameter of about 5 mm and a length of about 18 mm was produced. When the amount of the binder was adjusted to be 4%, and the fiber density was adjusted to be 2675 denier/mm², the porosity of the produced pen nib body was 67%, and the cross sectional hardness was 20.

The produced pen nib body was pretreated according to the same method as that in Second Example, and then the pyrrole monomer was subjected to a polymerization reaction according to the same method as that in Second Example.

The thus obtained pen nib integrated with polypyrrole had an electric leakage-resistant value of 1×10³ Ω/cm. The pen nib was severed by a cutter, and it was observed that the fiber inside the pen nib was coated with polypyrrole.

There was no problem about the durability, and a ground area set based on pressure equivalent to pressure in use was secured. A measured dynamic friction coefficient was 0.28, and there was no problem about the writing feeling/smoothness.

### Sixteenth Example

Using 5 denier nylon fiber and urethane resin as a binder, a rod-shaped pen nib body formed of a bundle of fibers and having a diameter of about 5 mm and a length of about 18 mm was produced. When the amount of the binder was adjusted to be 4%, and the fiber density was adjusted to be 2675 denier/mm², the porosity of the produced pen nib body was 67%, and the cross sectional hardness was 40.

The produced pen nib body was pretreated according to the same method as that in Second Example, and then the pyrrole monomer was subjected to a polymerization reaction according to the same method as that in Second Example.

The thus obtained pen nib integrated with polypyrrole had an electric leakage-resistant value of 1×10³ Ω/cm. The pen nib was severed by a cutter, and it was observed that the fiber inside the pen nib was coated with polypyrrole.

There was no problem about the durability, and a ground area set based on pressure equivalent to pressure in use was secured. A measured dynamic friction coefficient was 0.32, and there was no problem about the writing feeling/smoothness.

### Seventeenth Example

Using 20 denier nylon fiber and urethane resin as a binder, a rod-shaped pen nib body formed of a bundle of fibers and having a diameter of about 5 mm and a length of about 18 mm was produced. When the amount of the binder was adjusted to be 4%, and the fiber density was adjusted to be 2675 denier/mm², the porosity of the produced pen nib body was 67%, and the cross sectional hardness was 55.

The produced pen nib body was pretreated according to the same method as that in Second Example, and then the pyrrole monomer was subjected to a polymerization reaction according to the same method as that in Second Example.

The thus obtained pen nib integrated with polypyrrole had an electric leakage-resistant value of 1×10³ Ω/cm. The pen nib was severed by a cutter, and it was observed that the fiber inside the pen nib was coated with polypyrrole.

There was no problem about the durability, and a ground area set based on pressure equivalent to pressure in use was secured. A measured dynamic friction coefficient was 0.40, and there was no problem about the writing feeling/smoothness.

### Eighteenth Example

Using 25 denier nylon fiber and urethane resin as a binder, a rod-shaped pen nib body formed of a bundle of fibers and having a diameter of about 5 mm and a length of about 18 mm was produced. When the amount of the binder was adjusted to be 4%, and the fiber density was adjusted to be 2675 denier/mm², the porosity of the produced pen nib body was 67%, and the cross sectional hardness was 70.

The produced pen nib body was pretreated according to the same method as that in Second Example, and then the pyrrole monomer was subjected to a polymerization reaction according to the same method as that in Second Example.

The thus obtained pen nib integrated with polypyrrole had an electric leakage-resistant value of 1×10³ Ω/cm. The pen nib was severed by a cutter, and it was observed that the fiber inside the pen nib was coated with polypyrrole.

There was no problem about the durability, and a ground area set based on pressure equivalent to pressure in use was secured. A measured dynamic friction coefficient was 0.45, and as for the writing feeling/smoothness, the pen nib did not slide well.

### Nineteenth Example

Using 3 denier nylon fiber and urethane resin as a binder, a rod-shaped pen nib body formed of a bundle of fibers and having a diameter of about 2 mm and a length of about 18 mm was produced. When the amount of the binder was adjusted to be 4%, and the fiber density was adjusted to be 2675 denier/mm², the porosity of the produced pen nib body was 67%, and the cross sectional hardness was 37.

The produced pen nib body was pretreated according to the same method as that in Second Example, and then the pyrrole monomer was subjected to a polymerization reaction according to the same method as that in Second Example.

The thus obtained pen nib integrated with polypyrrole had an electric leakage-resistant value of 1×10³ Ω/cm. The pen nib was severed by a cutter, and it was observed that the fiber inside the pen nib was coated with polypyrrole.

There was no problem about the durability, and a ground area set based on pressure equivalent to pressure in use was not secured. A measured dynamic friction coefficient was 0.25, and there was no problem about the writing feeling/smoothness.

### Twentieth Example

Using 3 denier nylon fiber and urethane resin as a binder, a rod-shaped pen nib body formed of a bundle of fibers and having a diameter of about 3 mm and a length of about 18 mm was produced. When the amount of the binder was adjusted to be 4%, and the fiber density was adjusted to be 2675 denier/mm², the porosity of the produced pen nib body was 67%, and the cross sectional hardness was 37.

The produced pen nib body was pretreated according to the same method as that in Second Example, and then the pyrrole monomer was subjected to a polymerization reaction according to the same method as that in Second Example.

The thus obtained pen nib integrated with polypyrrole had an electric leakage-resistant value of 1×10³ Ω/cm. The pen nib was severed by a cutter, and it was observed that the fiber inside the pen nib was coated with polypyrrole.

There was no problem about the durability, and a ground area set based on pressure equivalent to pressure in use was not secured. A measured dynamic friction coefficient was 0.28, and there was no problem about the writing feeling/smoothness.

### Twenty-First Example

Using 3 denier nylon fiber and urethane resin as a binder, a rod-shaped pen nib body formed of a bundle of fibers and having a diameter of about 4 mm and a length of about 18 mm was produced. When the amount of the binder was adjusted to be 4%, and the fiber density was adjusted to be 2675 denier/mm², the porosity of the produced pen nib body was 67%, and the cross sectional hardness was 37.

The produced pen nib body was pretreated according to the same method as that in Second Example, and then the pyrrole monomer was subjected to a polymerization reaction according to the same method as that in Second Example.

The thus obtained pen nib integrated with polypyrrole had an electric leakage-resistant value of 1×10³ Ω/cm. The pen nib was severed by a cutter, and it was observed that the fiber inside the pen nib was coated with polypyrrole.

There was no problem about the durability, and a ground area set based on pressure equivalent to pressure in use was secured. A measured dynamic friction coefficient was 0.30, and there was no problem about the writing feeling/smoothness.

### Twenty-Second Example

Using 3 denier polyester fiber and urethane resin as a binder, a rod-shaped pen nib body formed of a bundle of fibers and having a diameter of about 5 mm and a length of about 18 mm was produced. When the amount of the binder was adjusted to be 20%, and the fiber density was adjusted to be 4000 denier/mm², the porosity of the produced pen nib body was 35%, and the cross sectional hardness was 105.

The produced pen nib body was pretreated according to the same method as that in Second Example, and then the pyrrole monomer was subjected to a polymerization reaction according to the same method as that in Second Example.

The thus obtained pen nib integrated with polypyrrole had an electric leakage-resistant value of 70×10³ Ω/cm. The pen nib was severed by a cutter, and it was observed that the fiber inside the pen nib was coated with polypyrrole.

There was no problem about the durability, and a ground area set based on pressure equivalent to pressure in use was not secured. A measured dynamic friction coefficient was 0.13, and as for the writing feeling/smoothness, it was slippery.

Examples 1 to 22 as described above are compiled in Tables 1 and 2.

TABLE 1

| | PEN NIB | | | | | | | | |
|---|---|---|---|---|---|---|---|---|---|
| | | | | FIBER | | BINDER | FIBER | | |
| | DIAMETER | LENGTH | | DIAMETER | BINDER | AMOUNT | DENSITY | POROSITY | |
| | Φ(mm) | (mm) | FIBER | (DENIER) | RESIN | (%) | (DENIER/mm²) | (%) | HARDNESS |
| EXAMPLE1 | 5 | 18 | NYLON | 3 | URETHANE | 4 | 2675 | 67 | 37 |
| EXAMPLE2 | 5 | 18 | NYLON | 3 | URETHANE | 4 | 2675 | 67 | 37 |
| EXAMPLE3 | 5 | 18 | NYLON | 3 | URETHANE | 1 | 2675 | 70 | 25 |
| EXAMPLE4 | 5 | 18 | NYLON | 3 | URETHANE | 10 | 2675 | 62 | 43 |
| EXAMPLE5 | 5 | 18 | NYLON | 3 | URETHANE | 40 | 2675 | 50 | 50 |
| EXAMPLE6 | 5 | 18 | NYLON | 3 | URETHANE | 50 | 2675 | 43 | 70 |
| EXAMPLE7 | 5 | 18 | NYLON | 3 | URETHANE | 55 | 2675 | 40 | 80 |
| EXAMPLE8 | 5 | 18 | NYLON | 3 | URETHANE | 4 | 1300 | 85 | 3 |
| EXAMPLE9 | 5 | 18 | NYLON | 3 | URETHANE | 4 | 2000 | 76 | 25 |
| EXAMPLE10 | 5 | 18 | NYLON | 3 | URETHANE | 4 | 4000 | 55 | 48 |
| EXAMPLE11 | 5 | 18 | NYLON | 3 | URETHANE | 4 | 5000 | 35 | 60 |
| EXAMPLE12 | 5 | 18 | NYLON | 3 | URETHANE | 4 | 6000 | 22 | 73 |
| EXAMPLE13 | 5 | 18 | NYLON | 3 | URETHANE | 4 | 7600 | 18 | 80 |
| EXAMPLE14 | 5 | 18 | NYLON | 0.7 | URETHANE | 4 | 2675 | 67 | 18 |
| EXAMPLE15 | 5 | 18 | NYLON | 1 | URETHANE | 4 | 2675 | 67 | 20 |
| EXAMPLE16 | 5 | 18 | NYLON | 5 | URETHANE | 4 | 2675 | 67 | 40 |
| EXAMPLE17 | 5 | 18 | NYLON | 20 | URETHANE | 4 | 2675 | 67 | 55 |
| EXAMPLE18 | 5 | 18 | NYLON | 25 | URETHANE | 4 | 2675 | 67 | 70 |
| EXAMPLE19 | 2 | 18 | NYLON | 3 | URETHANE | 4 | 2675 | 67 | 37 |
| EXAMPLE20 | 3 | 18 | NYLON | 3 | URETHANE | 4 | 2675 | 67 | 37 |
| EXAMPLE21 | 4 | 18 | NYLON | 3 | URETHANE | 4 | 2675 | 67 | 37 |
| EXAMPLE22 | 5 | 18 | POLYESTER | 3 | URETHANE | 20 | 4000 | 35 | 105 |

Note:
The concentration of pyrrole in conductive processing was 3% in First Example while 4% in the other Examples.

TABLE 2

| | EVALUATION | | | | | |
|---|---|---|---|---|---|---|
| | | | | SECURED | DYNAMIC | WRITING |
| | RESISTANCE | INSIDE | | GROUND | FRICTION | FEELING/ |
| | VALUE(Ω) | STATE | DURABILITY | AREA | COEFFICIENT | SMOOTHNESS |
| EXAMPLE1 | 70K | ◯ | ◯ | ◯ | 0.30 | ◯ |
| EXAMPLE2 | 1K | ◯ | ◯ | ◯ | 0.30 | ◯ |
| EXAMPLE3 | 1K | ◯ | ◯ | ◯ | 0.28 | ◯ |
| EXAMPLE4 | 1K | ◯ | ◯ | ◯ | 0.33 | ◯ |
| EXAMPLE5 | 50K | ◯ | ◯ | ◯ | 0.35 | ◯ |
| EXAMPLE6 | 90K | X | ◯ | ◯ | 0.38 | ◯ |
| EXAMPLE7 | 150K | X | ◯ | X | 0.34 | ◯ |
| EXAMPLE8 | 1K | ◯ | X | ◯ | 0.14 | X |
| EXAMPLE9 | 1K | ◯ | X | ◯ | 0.31 | ◯ |
| EXAMPLE10 | 70K | ◯ | ◯ | ◯ | 0.31 | ◯ |
| EXAMPLE11 | 80K | ◯ | ◯ | ◯ | 0.32 | ◯ |
| EXAMPLE12 | 80K | ◯ | ◯ | X | 0.31 | ◯ |
| EXAMPLE13 | 100K | X | ◯ | X | 0.30 | ◯ |
| EXAMPLE14 | 1K | ◯ | ◯ | ◯ | 0.20 | ◯ |
| EXAMPLE15 | 1K | ◯ | ◯ | ◯ | 0.28 | ◯ |
| EXAMPLE16 | 1K | ◯ | ◯ | ◯ | 0.32 | ◯ |
| EXAMPLE17 | 1K | ◯ | ◯ | ◯ | 0.40 | ◯ |
| EXAMPLE18 | 1K | ◯ | ◯ | ◯ | 0.45 | X |
| EXAMPLE19 | 1K | ◯ | ◯ | X | 0.25 | ◯ |
| EXAMPLE20 | 1K | ◯ | ◯ | X | 0.28 | ◯ |
| EXAMPLE21 | 1K | ◯ | ◯ | ◯ | 0.30 | ◯ |
| EXAMPLE22 | 70K | ◯ | ◯ | X | 0.13 | X |

As can be understood from the above Tables 1 and 2, when a pen nib for a touch pen is produced by providing a pen nib body formed of a bundle of fibers with conductivity, the resistance value of the pen nib is affected by an inside state of the pen nib. This is probably because coating with polypyrrole—a conductive polymer—reached the fiber inside the pen nib, and as a result the entire pen nib is made conductive. The inside state of the pen nib can be optimized by adjusting the porosity of the pen nib body and the amount of binder.

More specifically, with the porosity of the bundle of fibers that forms the pen nib body being adjusted to be 20% or more, the conductive material can sufficiently be passed through the bundle of fibers; and with the binder amount being adjusted to be 40% or less, the binder does not coat the fiber that forms the bundle of fibers more than necessary, whereby the fiber inside the bundle of fibers that forms the pen nib body is coated with polypyrrole and the resistance value of the pen nib can be 80×10³ Ω/cm or less, and moreover a favorable pen nib for a touch pen having excellent conductivity can be produced.

As in the foregoing, the pen nib according to the present invention is configured by coating the surface of a pen nib body formed of a bundle of fibers with a conductive material and also by making the pen nib body conductive, and therefore the pen nib body has hardness or the like comparable to that of a usual pen nib formed of a bundle of fibers, hence the pen nib can be used for operating a touch panel or the like with the same writing feeling as that offered by a usual pen.

In particular, pyrrole used as a conductive material to coat a surface of a pen nib body formed of a bundle of fibers has sufficient conductivity if formed as a thin film, hence a resulting pen nib formed of a bundle of fibers can be used for operating a touch panel, or the like, as a pen nib having no effect on the intrinsic character of a pen nib formed of a bundle of fibers and imparting the same feeling as a usual pen nib.

Moreover, when a pen nib body formed of a bundle of fibers has a surface coated with a conductive material and is made conductive, the porosity of the bundle of fibers that forms the pen nib body is set to 20% or more, and the amount of the binder is set to 40% or less, so that the resistance value of the pen nib for a touch pen can be 80×10³ Ω/cm or less, whereby the pen nib can be provided with sufficient conductivity.

### REFERENCE SIGNS LIST

1 pen nib

2 holder tube

3 conductive fabric

1. A pen nib comprising a pen nib body formed of a bundle of fibers, wherein the pen nib body is coated with a conductive material and made conductive.

2. The pen nib according to claim 1, wherein pyrrole is used as the conductive material.

3. The pen nib according to claim 1, wherein the pen nib body is formed of a bundle of fibers produced by binding synthetic fibers with a binder, the bundle of fibers has a porosity from 20% to 80%, and a ratio of the binder relative to a total weight is from 1% to 40%.

4. The pen nib according to claim 2, wherein the pen nib body is formed of a bundle of fibers produced by binding synthetic fibers with a binder, the bundle of fibers has a porosity from 20% to 80%, and a ratio of the binder relative to a total weight is from 1% to 40%.
